(19) United States
(12) Patent Application Publication
(10) Pub. No.: US 2009/0183187 A1
(43) Pub. Date: Jul. 16, 2009

(54) Providing Command Line Interface Using a Remote Interface

(76) Inventors: Lazar Borissov, Sofia (BG); Nina Petrova, Sofia (BG)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/015,014

(22) Filed: Jan. 16, 2008

(51) Int. Cl. G06F 9/44

(52) U.S. Cl. 719/330

(57) ABSTRACT

A method and system to invoke business logic via a remote interface is described. The remote interface is used as a single point of entry to the business logic for both local and remote connectivity.

### FIELD OF INVENTION

The invention relates generally to software development, and, more specifically, to implementing a command line interface using a client server architecture.

### BACKGROUND

Software development involves a number of phases, such as design, development, testing, and implementation. Each phase requires substantial effort on the part of software developers. In large software environments such as enterprise software systems, each software component has to be extensively tested for all use cases it is part of. It is estimated that the effort required for testing a software component is more than the effort required to develop the software component.

In a software application, the functionality of the application is encapsulated in one or more software components collectively referred to as the “business logic” of the application. The business logic of the application is exposed to external components and other applications using interface modules.

The use case of an application may require different types of connectivity, such as remote connectivity or local connectivity. Remote connectivity is provided using remote interfaces and is intended for use cases where other applications or components need to connect to the application from a physical location that is different from the physical location where the application resides. Local connectivity is provided for components or applications that reside on the same physical location as the application.

An example of a component using local connectivity is a command line interface. A command line interface connects directly to the business logic of the application. Thus, there are two parallel workflows involved: the command line interface and the remote interface. Because of these two use cases, each time new functionality is added to the application, this new functionality has to be tested twice. In addition, when new functionality is developed it has to be developed twice—once for the command line interface, and once for the remote interface. That is, the described scenario involves double maintenance of software applications.

Also, as the command line interface and the remote interface have their own semantics, that is, they function differently. Consequently, their behavior is inconsistent and requires dedicated maintenance efforts. In terms of low-level system functionality, it is also possible that the command line interface obtains access to parts of the business logic that are not intended for use. The outcome of such events is unpredictable.

### SUMMARY

A system and method for accessing business logic from a command line interface via a remote interface is described.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a bock diagram of a system of an embodiment of the invention for executing work from a command line interface using a remote interface.

FIG. 2 is a flow diagram of an embodiment of the invention for executing work from a command line interface on an application using a remote interface.

### DETAILED DESCRIPTION

A method and system to invoke business logic via a remote interface is described. The remote interface is used as a single point of entry to the business logic for both local and remote connectivity.

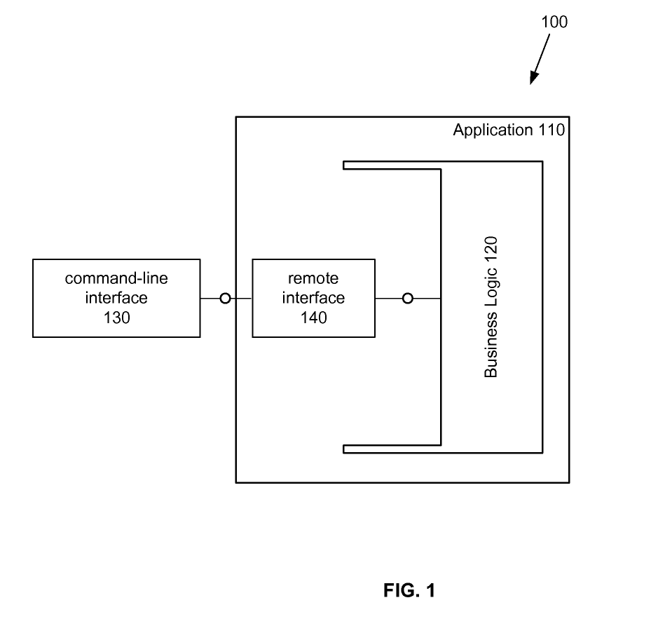

FIG. 1 is a bock diagram of a system of an embodiment of the invention for executing work from a command line interface using a remote interface. Referring to FIG. 1, the system 100 includes an application 110. The application 110 encapsulates business functionality in its business logic 120. The business logic 120 encapsulates the functionality embedded in the application 110. To use the functionality provided in the application 110, a client must obtain access to it. The business logic 120 exposes its functionality via a remote Application Programming Interface (API) 140. The remote API 140 is the single point of entry to the business logic 120. The system 100 also includes a command line interface 130 that accepts parameters specifying work to be executed by the application 110. From an operating system (“OS”) point of view, the command line interface 130 executes on a dedicated operating system process. The command line interface 130 instructs the application 110 to execute work via network calls performed using the remote interface 140.

The architecture of the system 100 as described in FIG. 1 has a number of benefits. From an application development point of view, after the development of certain functionality, this functionality has to be tested for all use cases that the functionality is involved in. Because the system 100 exposes the business logic 120 of the application 110 only via the remote interface 140, test scenarios of the system 100 are significantly simplified. For example, there is no need to provide separate test scenarios for the command line interface 130 and the remote interface 140 as the remote interface 140 covers the functionality available to the command line interface 130.

From a maintenance point of view, the system 100 is easily scalable and maintainable. If new features must be implemented in the system 100, they will be implemented once only and will be available via the remote interface 140. If a remote interface and a command line interface connect independently to business logic, all new features would have to be implemented twice; once for the semantic of the command line interface and a second time for the semantic of the remote interface. Thus, a system would involve twice the effort for maintenance. Because the system 100 exposes its functionality through the remote interface 140 only, there is no additional maintenance effort involved.

From a connectivity point of view, because the remote interface 140 and the command line interface 130 do not connect independently to the business logic 120, only one connection to the business logic 120 is needed. The more the connections, the more the load on the system 100. As the command line interface 130 accesses the business logic 120 only via the remote interface 140, only one connection is needed at any given time and the usage of critical system resources is kept to a minimum.

From a functional perspective, because the remote interface 140 and the command line interface 130 do not connect independently to the business logic 120, it is not possible for the command line interface 130 to obtain access to some low level system functionality that was not originally intended for the command line interface 130. If the command line interface obtains access to low level system functionality, the outcome would be unpredictable and hard to deal with. Because the command line interface 130 in the system 100 connects to the application 110 only through the remote interface 140, the command line interface 130 can only access the functionality intended for it. Thus, the behavior of the command line interface 130 is predictable and reliable.

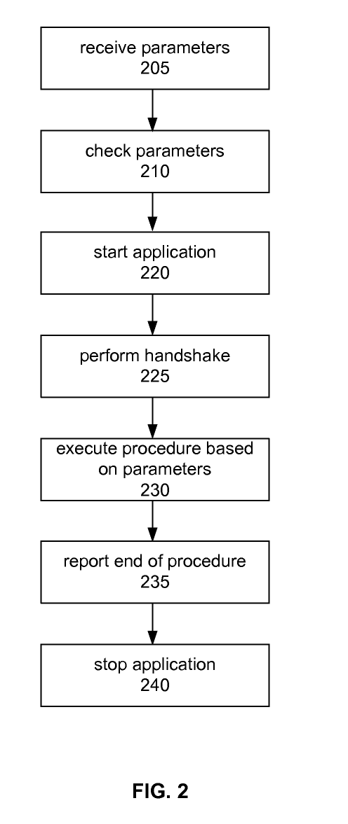

FIG. 2 is a flow diagram of an embodiment of the invention for executing work from a command line interface on an application using a remote interface. At process block 205 input is supplied to the command line interface. The supplied input is parameters specifying a procedure to be performed. The supplied parameters are of two types. The first type of parameters is parameters that specify the business functions to be executed. The second type of parameters is data that is needed by the business functions to execute. For example, in an exemplary system, the command line interface is used to receive parameters specifying a maintenance procedure to be performed on a software environment. In such a case the exemplary input supplied to the command line interface may be of the following format: “dvd javadvd=E:\\java_dvd”. In this exemplary input, “dvd” would be of the first type of parameters, that is, “dvd” tells the system to apply a maintenance procedure from a DVD location. The second part of the input, “javadvd=E:\\java_dvd” tells the system where the data needed for the procedure resides, and as such, is of the second type of parameters. At process block 210 the parameters are checked for validity. The remote interface starts an application to perform the procedure specified by the parameters at process block 220. At process block 225, the remote interface performs a handshake with the application to open a connection to the application. At process block 230 the system executes the procedure based on the received parameters. When the procedure is complete, the system reports the end of the procedure at process block 235. Upon the confirmation for the completed procedure, the system stops the application at process block 240.

In one embodiment of the invention, the method described in FIG. 2 is performed by components as described in FIG. 1. Referring to FIGS. 1 and 2, the command line interface 130 receives parameters at process block 205. The command line interface 130 checks the validity of the parameters at process block 210. The remote interface 140 starts the application 110 at process block 220. At process block 225 the remote interface 140 opens a connection to the application 110 by performing a handshake with the application 110. At process block 235 the application 110 initializes its business logic 120 to perform the procedure as specified by the received parameters. After the procedure is complete the application 110 confirms the end of the procedure at process block 235. At process block 240, the command line interface 130 stops the application 110 via the remote interface 140.

Elements of embodiments may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cares, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
receiving input at a command line interface;
sending the input from the command line interface to a remote interface; and
executing a procedure based on the received input responsive to the remote interface initializing business logic.

2. The method of claim 1, further comprising:
receiving an indication at the remote interface that the procedure has completed; and
stopping the business logic via the remote interface.

3. The method of claim 1, wherein receiving input comprises:
receiving parameters at the command line interface specifying a procedure to be performed; and
checking the validity of the received parameters at the command line interface.

4. The method of claim 1, wherein executing the procedure comprises:
starting an application comprising the business logic via the remote interface;
establishing a connection with the application via the remote interface responsive to a confirmation that the application is started; and
translating the received input into the procedure to be performed.

5. A computing system comprising:
a command line interface to receive parameters specifying a procedure to be performed;
a remote interface to receive the parameters from the command line interface; and
an application to perform the procedure responsive to receiving the parameters from the remote interface.

6. The system of claim 5, wherein the application comprises business logic encapsulating business functionality.

7. The system of claim 5, wherein the command line interface further checks the validity of the received parameters.

8. The system of claim 5, wherein the remote interface comprises functionality to translate the received parameters into a procedure for the application to perform.

9. An article of manufacture, comprising a machine readable medium having instructions therein that when executed by the machine, cause the machine to:
receive input at a command line interface;
send the input from the command line interface to a remote interface; and
execute a procedure based on the received input responsive to the remote interface initializing business logic.

10. The article of manufacture of claim 9, further comprising instructions that cause the machine to:
receive an indication at the remote interface that the procedure has completed; and
stop the business logic via the remote interface.

11. The article of manufacture of claim 9, wherein instructions causing the machine to receive input, cause the machine to:
receive parameters at the command line interface specifying a procedure to be performed; and
check the validity of the received parameters at the command line interface.

12. The article of manufacture of claim 9, wherein instructions causing the machine to execute the procedure, cause the machine to:
start an application comprising the business logic via the remote interface;
establish a connection with the application via the remote interface responsive to a confirmation that the application is started; and
translate the received input into the procedure to be performed.
